(19) United States
(12) Patent Application Publication
(10) Pub. No.: US 2024/0103862 A1
(43) Pub. Date: Mar. 28, 2024

(54) COMPUTING DEVICE AND COMPUTING METHOD

(71) Applicant: Fujitsu Limited, Kawasaki-shi (JP)

(72) Inventor: Yuki KAMIKUBO, Yokohama (JP)

(73) Assignee: Fujitsu Limited, Kawasaki-shi (JP)

(21) Appl. No.: 18/326,202

(22) Filed: May 31, 2023

(30) Foreign Application Priority Data
Sep. 22, 2022 (JP) 2022-151924

(51) Int. Cl. G06F 9/30; G06F 9/32

(52) U.S. Cl. CPC G06F 9/30047; G06F 9/321

(57) ABSTRACT

A computing device includes a memory and a processor coupled to the memory and configured to stride width based on request addresses of respective two memory access instructions that are presented by a given program counter and detect occurrence of a stride access based on request addresses of a plurality of memory access instructions that are presented by the given program counter and the calculated a stride width, and issue a prefetch request based on the stride width When the stride access is detected.

### CROSS-REFERENCE TO RELATED APPLICATION

This application is based upon and claims the benefit of priority of the prior Japanese Patent Application No. 2022-151924, filed on Sep. 22, 2022, the entire contents of which are incorporated herein by reference.

### FIELD

The embodiments discussed herein are related to a computing device and a computing method.

### BACKGROUND

A computer includes a hierarchical cache memory between a central processing unit (CPU) core and a main storage device to make improvements in hiding latency of access to the main storage device and a lower-level cache memory and in short throughputs. Furthermore, fast cores and many cores in recent CPUs are increasing and it is important to increase the hit ratio of the cache memory and hide latency of cache misses.

Prefetching that reduces occurrence of cache misses by reading data that is predicted to be used in the near future in a cache memory is being introduced as a method of increasing the hit ratio of the cache memory and hiding cache miss latency. There are a technique using software and referred to as software prefetching and a technique using hardware and referred to as hardware prefetching as a method of realizing prefetching.

A technique referred to as stream prefetching and a technique referred to as stride prefetching have been often employed as hardware prefetching. Stream prefetching is hardware prefetching of performing prefetching on stream accesses that are successive accesses on a cache line basis. Stride prefetching is hardware prefetching of performing prefetching on fixed stride accesses at given intervals.

The case where memory access instructions, such as a load instruction and a memory access instruction like an access A1, an access A2, . . . , make accesses to given positions in a main memory according to the order of sequential numbers will be described. For example, when the access A1, the access A2, . . . make sequential accesses on a cache line basis, the CPU is capable of stream prefetching. For example, the CPU detects that the accesses are stream accesses from the cache memory addresses that are accessed by the access A1, an access A2, and an access A3. The CPU predicts that an access will come to the cache line following the cache memory address of the access A3 and reads an area that an access A4 will access into the cache memory previously by prefetching. As a result, because the data is already registered in the cache memory when the instruction of the access A4 is executed, the CPU is able to inhibit occurrence of a cache miss, which improves computing performance.

On the other hand, when the access A1, the access A2, . . . make accesses to cache lines at constant intervals, the CPU is capable of stride prefetching. For example, the CPU detects that accesses are made to every other cache line from the cache memory addresses (addresses) that are accessed by the access A1, the access A2, and the access A3. The CPU predicts that accesses to every other cache line will occur after the access A3 and reads an area that the access A4 will access into the cache memory previously by prefetching. Also in this case, because the data is already registered in the cache memory when the instruction of the access A4 is executed, the CPU is able to inhibit occurrence of a cache miss, which improves computing performance. The cache line width of the constant intervals is referred to as a stride width.

The stride access can be separated into uni-stride access and multi-stride access. The uni-stride access is the case where accesses occur with the fixed stride width. On the other hand, the multi-stride width is the case where accesses occur with coexisting multiple stride widths. The multi-stride access is, for example, the case where an access with a first stride width occurs for a given number of times and thereafter an access with a different second stride width occurs. Note that, even in the case of multi-stride access, when two types of stride widths of a stride width within a cache line size and a stride width exceeding the cache line size coexist, an access can be regarded as unit-stride access on a cache line basis.

As for such a prefetching technique, a technique of determining a stride width by a difference between previous and next addresses, counts the number of stride widths in each memory access, and performing prefetching when the counter is at or over an upper limit has been proposed. Furthermore, a technique of increasing or reducing the counter according to whether the stride width is within a given range, calculating a stride width based on the value of the counter, and performing prefetching has been proposed.
Patent Literature 1: Japanese National Publication of International Patent Application No. 2006-510082
Patent Literature 2: Japanese National Publication of International Patent Application No. 2013-539117

In stride access for which the conventional stride prefetching is performed is uni-stride access. In the conventional stride prefetching, access patterns are not distinguished by uni-stride access and multi-stride access and uni-stride prefetching is started even on multi-stride accesses. Starting uni-stride prefetching for multi-stride access may cause prefetching using a wrong address. In this case, there is a risk of lowering performance of the CPU that results from cache poisoning and compression of the memory bandwidth because of storage of unnecessary data in the cache.

For example, the stride width is 128 bytes in many cases and, for this reason, conventional techniques starts prefetching at 128 bytes. When the stride width changes to another stride width, such as 192 bytes, the address of prefetching indicates inappropriate data and wrong prefetching occurs. The same applies to multi-stride access that can be regarded as a unit-stride access on a cache line basis.

The technique of performing prefetching when the count of the number of stride widths is at or above the upper limit has a risk that it is not possible to sufficiently follow changes in the stride width and wrong prefetching will occur. The technique of calculating a stride width based on the counter that is increased or reduced according to whether the stride width is within the given range and performing prefetching has a risk that wrong prefetching will occur. It is thus difficult to increase the computing performance of the CPU with any of the techniques.

### SUMMARY

According to an aspect of an embodiment, a computing device includes: a memory and a processor coupled to the memory and configured to, calculate a stride width based on request addresses of respective two memory access instructions that are presented by a given program counter and detect occurrence of a stride access based on request addresses of a plurality of memory access instructions that are presented by the given program counter and the calculated stride width, and issue a prefetch request based on the stride width when the stride access is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an entire configuration of an information processing device;

FIG. 2 is a block diagram illustrating details of a CPU according to an embodiment;

FIG. 3 is a diagram illustrating an example of a format of entries that are stored in a pre-fetch queue according to a first embodiment;

FIG. 4 is a diagram illustrating a state machine that manages states of the entries of the pre-fetch queue;

FIG. 5 is a diagram illustrating a list of information that is updated in each entry at state transition;

FIG. 6 is a diagram illustrating an example of transition of entries in a case of uni-stride access;

FIG. 7 is a diagram illustrating an example of accesses and prefetching in the case of uni-stride access;

FIG. 8 is a diagram illustrating an example of transition of entries in the case of multi-stride access;

FIG. 9 is a diagram illustrating an example of accesses in the case of transition of entries in the case of multi-stride access;

FIG. 10 is a diagram illustrating an example of transition of entries in a case of multi-stride access that is however is uni-stride access when viewed on a cache line basis;

FIG. 11 is a diagram illustrating an example of accesses and prefetching in the case of multi-stride access that is however uni-stride access when viewed on a cache line basis;

FIG. 12 is a flowchart of prefetching performed by a CPU according to the first embodiment;

FIG. 13 is a flowchart of a state updating process performed by a state manager;

FIG. 14 is a flowchart of execution of the state updating process in a state #2;

FIG. 15 is a flowchart of execution of the state updating process in a state #3;

FIG. 16 is a flowchart of execution of the state updating process in a state #4;

FIG. 17 is a diagram illustrating an example of a format of entries that are stored in a pre-fetch queue according to a second embodiment;

FIG. 18 is a diagram illustrating an example of a state machine for replacement control; and

FIG. 19 is a flowchart of pre-fetching performed by a CPU according to the second embodiment.

### DESCRIPTION OF EMBODIMENTS

Preferred embodiments of the present invention will be explained with reference to accompanying drawings. The following embodiments do not limit the arithmetic processing device and the arithmetic processing method disclosed herein.

### (a) First Embodiment

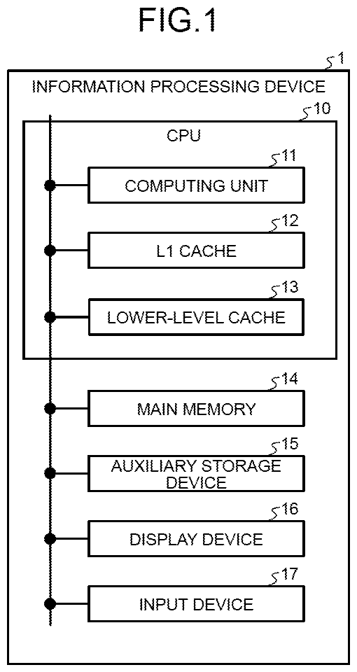

FIG. 1 is a schematic diagram illustrating an entire configuration of an information processing device. As illustrated in FIG. 1, an information processing device 1 includes a computing unit 11, an L1 cache 12, a lower-level cache 13, a main memory 14, an auxiliary storage device 15, a display device 16, and an input device 17. The computing unit 11 is connected to each of the computing unit 11, the L1 cache 12, the lower-level cache 13, the main memory 14, the auxiliary storage device 15, the display device 16, and the input device 17 via a bus. The computing unit 11, the L1 cache 12, and the lower-level cache 13 are on, for example, a CPU 10 that is a computing device.

The computing unit 11 is, for example, a central processing unit (CPU) core. The computing unit 11 reads various types of programs that are stored in the auxiliary storage device 15, loads the programs into the main memory 14, and executes computing using data that is stored in the L1 cache 12, the lower-level cache 13, and the main memory 14.

The L1 cache 12 is a cache memory whose processing speed is high and whose capacity is smaller than that of the lower-level cache 13 and that is read first when the computing unit 11 makes a data access. The L1 cache 12 is, for example, a static random access memory (SRAM).

The lower-level cache 13 is a cache memory whose processing speed is high and whose capacity is larger than that of the L1 cache 1 and that is read next in a case where a cache miss occurs in the L1 cache memory when the computing unit 11 makes a data access. The lower-level cache 13 is an L2 cache or a L3 cache. The lower-level cache 13 is, for example, a SRAM.

The number of layers of the lower-level cache 13 is not limited to this. For example, the information processing device 1 may include two layers or four or more layers as cache layers.

The main memory 14 is a main storage device whose processing speed is lower than that of the L1 cache 12 and the lower-level cache 13 and whose capacity is large. The main memory 14 stores data that is used by the computing unit 11 for computing. The main memory 14 is accessed by the computing unit 11 in a case where there is not data to be accessed in any of the L1 cache 12 and the lower-level cache 13. The main memory 14 is, for example, a dynamic random access memory (DRAM).

The auxiliary storage device 15 is, for example, a hard disk drive (HDD) or a solid state drive (SSD). The auxiliary storage device 15 stores an operating system (OS) and various types of programs for computing.

The display device 16 is, for example, a monitor or a display. The display device 16 makes a presentation of the result of computing by the computing unit 11 to a user, etc. The input device 17 is, for example, a keyboard or a mouse. The user inputs data and instructions to the information processing device 1 with the input device 17 while referring to the screen that is displayed on the display device 16. The display device 16 and the input device 17 may be configured as a single set of hardware.

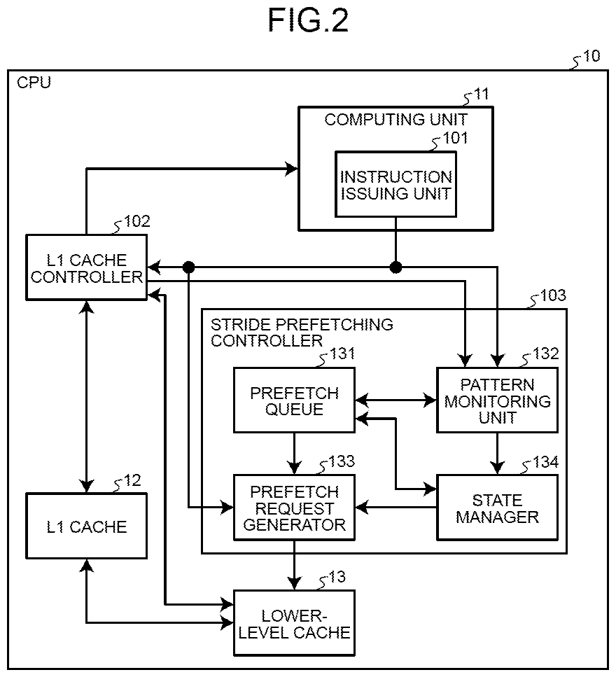

FIG. 2 is a block diagram illustrating details of the CPU according to the embodiment. The CPU 10 includes an instruction issuing unit 101 that the computing unit 11 includes, an L1 cache controller 102, a stride prefetching controller 103, the L1 cache 12, and the lower-level cache 13.

The instruction issuing unit 101 issues a memory access instruction, such as a read instruction, to the L1 cache controller 102 according to computing by the computing unit 11, etc. The instruction issuing unit 101 notifies the stride prefetching controller 103 of a request address of a memory access instruction and a program counter.

The L1 cache controller 102 receives the memory access instruction from the instruction issuing unit 101. The L1 cache controller 102 receives, from a pattern monitoring unit 132, a program counter (PC) miss notification notifying that there is not data in a prefetch queue 131 that the stride prefetching controller 103 includes. The L1 cache controller 102 determines whether data that is specified by the memory access instruction is stored in the L1 cache 12. The case where data that is specified by a memory access instruction is not stored in the L1 cache 12 is referred to as a L1 cache miss. The case where data that is specified by a memory access instruction is stored in the L1 cache 12 inversely is referred to as a L1 cache hit.

In the case of a L1 cache hit, the L1 cache controller 102 acquires the data that is specified by the memory access instruction from the L1 cache 12 and outputs the data to the computing unit 11. The L1 cache controller 102 notifies the pattern monitoring unit 132 of the L1 cache hit.

On the other hand, in the case of the L1 cache miss, the L1 cache controller 102 outputs a request to acquire the data that is specified by the memory access instruction to the lower-level cache 13. Thereafter, the L1 cache controller 102 acquires the data that is specified by the memory access instruction from the lower-level cache 13, outputs the data to the computing unit 11, and stores the data in the L1 cache 12. The L1 cache controller 102 notifies the pattern monitoring unit 132 of the L1 cache miss.

The stride prefetching controller 103 includes the prefetch queue 131, the pattern monitoring unit 132, a prefetch request generator 133, and a state manager 134.

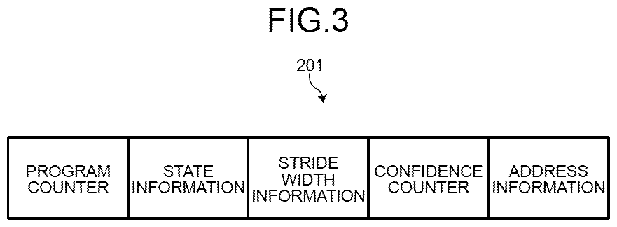

The prefetch queue 131 includes, for example, N+1 entries. FIG. 3 is a diagram illustrating an example of a format of entries that are stored in a pre-fetch queue according to the first embodiment. As illustrated in a format 201, a program counter, state information, stride width, a confidence counter, and address information are registered in each entry of the prefetch queue 131.

The program counter represents a program counter for memory access instructions on prefetched data that is stored in the prefetch queue 131. The state information is information on the state representing in which state the entry in the prefetch queue 131 is. In the first embodiment, there are five states #1 to #4 as the state. The state #0 represents an invalid state, that is, a vacant entry. The state #1 represents an initial registration state. The state #2 represents a stride width registration state. The state #3 represents a state with an address hit in the previous access. The state #4 represents a state in which there is an address miss in the previous access. The confidence counter is information representing confidence of stride access.

Back to FIG. 2, description will be continued. When a memory access instruction from the instruction issuing unit 101 is issued, the pattern monitoring unit 132 receives a notification of a request address and a program counter of the memory access instruction from the instruction issuing unit 101. The pattern monitoring unit 132 searches the prefetch queue 131 according to the program counter of the memory access instruction. As for the search, the case where an entry with the matching program counter is registered in the prefetch queue 131 is referred to as “a program counter (PC) hit”. Inversely, the case where the entry with the matching program counter is not registered in the prefetch queue 131 is referred to as “a PC miss”.

In the case of a PC hit, the pattern monitoring unit 132 notifies the state manager 134 of the PC hit and the value of the program counter of the entry.

In the case of a PC miss, the pattern monitoring unit 132 notifies the state manager 134 of the PC miss. Thereafter, in the case of an L1 cache miss, the pattern monitoring unit 132 receives a notification of the L1 cache miss from the L1 cache controller 102. The pattern monitoring unit 132 determines whether the prefetch queue 131 has a vacancy to store a new entry.

When the prefetch queue 131 has a vacancy, the pattern monitoring unit 132 sets, at the state #1, the state information of an entry to be registered newly with respect to the memory access instruction on which the L1 cache miss occurs. The pattern monitoring unit 132 sets the program counter of the entry that is registered newly at the program counter of the memory access instruction. The pattern monitoring unit 132 registers the request address of the memory access instruction as a predicted address in the address information of the entry that is registered newly. Here, because the stride width information is invalid in the state #1, the pattern monitoring unit 132 registers a freely selected value, such as an initial value that is determined previously, as stride width information. The pattern monitoring unit 132 registers the new entry with the above-described content in the prefetch queue 131.

On the other hand, when the prefetch queue 131 has no vacancy, the pattern monitoring unit 132 searches for an entry that is stored for the longest time in the prefetch queue 131 and deletes the entry. Thereafter, the pattern monitoring unit 132 registers an entry corresponding to the memory access instruction on which the L1 cache miss occurs in the prefetch queue 131 according to the same procedure as that in the case where the prefetch queue 131 has a vacancy. The pattern monitoring unit 132 corresponds to an example of “a monitoring unit”. The memory access instruction corresponding to the entry that is registered newly by the pattern monitoring unit 132 corresponds to an example of “a first memory access instruction”. The entry that is registered newly by the pattern monitoring unit 132 corresponds to an example of “a given entry”.

As described above, when a cache miss occurs with respect to a first memory access instruction that is presented by a given program counter and a given entry containing information of the given program counter is not in the prefetch queue 131, the pattern monitoring unit 132 performs the process below. In other words, the pattern monitoring unit 132 registers the given entry containing the information of the given program counter in the prefetch queue 131.

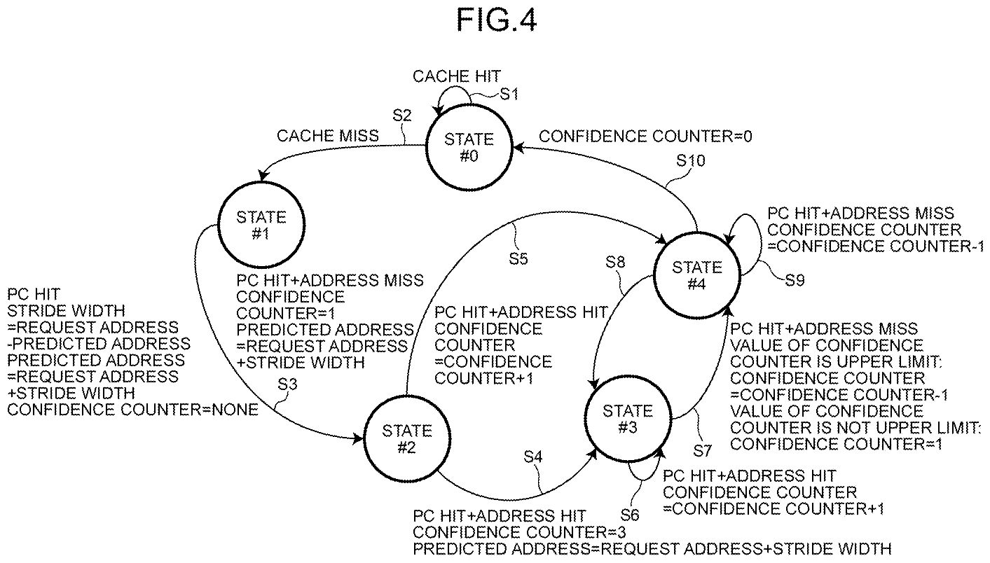

FIG. 4 is a diagram illustrating a state machine that manages the states of the entries in the prefetch queue. Entries do not increase newly if no cache miss occurs and therefore the pattern monitoring unit 132 keeps the states of the entries in the prefetch queue 131 at that time (step S1).

On the other hand, when a cache miss occurs, the pattern monitoring unit 132 newly registers, in the prefetch queue 131, an entry in which a value of a program counter of a memory access instruction with respect to which the cache miss occurs is registered and sets the state information at state #1. In other words, the pattern monitoring unit 132 causes the entry in the state #0 to transition to the state #1 (step S2).

Back to FIG. 2, the description will be continued. The state manager 134 receives a notification of a PC hit and a value of a program counter of an entry in which the PC hit occurs from the pattern monitoring unit 132. The state manager 134 updates state information of the entry in the prefetch queue 131 in which the PC hit occurs and the value of the confidence counter according to the state machine. The state manager 134 corresponds to an example of “a manager”.

With reference to FIG. 4, a process of updating state information will be described below. Here, a PC hit occurs and an entry with a program counter whose value is acquired by the state manager 134 from the pattern monitoring unit 132 is referred to as “a subject entry”. The state in which the state information of the entry is any of the states #1 to #4 is sometimes referred to as a state in which the entry is in any of the states #1 to #4 below. The state manager 134 acquires the state information, the stride width information, the value of the confidence counter, and the address information of the subject entry from the prefetch queue 131.

When the subject entry is in the state #1, the state manager 134 changes the state information of the subject entry to the state #2 and causes the subject entry to transition from the state #1 to the state #2. The state manager 134 subtracts the predicted address that is registered in the entry from the request address of the memory access instruction with respect to which a PC hit occurs and registers the calculation result as a stride width from the previous access in the stride width information of the subject entry. Furthermore, the state manager 134 calculates a predicted address by summing the request address and the stride width and registers the calculated predicted address as the address information of the subject entry (step S3). The predicted address that is stored in the address information is a predicted value of a request address of a memory access instruction that comes next and that has the same program counter.

When the subject entry is in any one of the states #2 to #4, a predicted address of the same program counter to be issued next is registered in the address information. Thus, when the subject entry is in any one of the states #2 to #4, the state manager 134 performs an address hit determination of determining whether the request address and the predicted address that is registered in the entry match. The case where the request address and the predicted address registered in the entry match is referred to as “an address hit”. Inversely, the case where the request address and the predicted address registered in the entry do not match is referred to as “an address miss”.

When there is an address hit in the case where the subject entry is in the state #2, the state manager 134 causes the subject entry to transition to the state #3. The state manager 134 sets the confidence counter at 3 (step S4).

On the other hand, when there is an address miss in the case where the subject entry is in the state #2, the state manager 134 causes the subject entry to transition to the state #4. Furthermore, the state manager 134 sets the confidence counter at 1 (step S5).

In any of the cases of an address hit and an address miss, the state manager 134 calculates a predicted address by adding a stride width to a request address and registers the calculated predicted address in the address information of the subject entry.

When there is an address hit in the case where the subject entry is in the state #3, the state manager 134 increments the confidence counter by 1 while maintaining the state information of the subject entry at the state #3 (step S6).

On the other hand, when there is an address miss in the case where the subject entry is in the state #3, the state manager 134 determines whether the value of the confidence counter of the subject entry reaches a predetermined upper value. When the value of the confidence counter of the subject entry does not reach the upper limit, the state manager 134 sets the confidence counter at 1. On the other hand, when the value of the confidence counter of the subject entry reaches the upper limit, the state manager 134 decrements the confidence counter by 1 while maintaining the state information of the subject entry at the state #4. The state manager 134 then causes the subject entry to transition to the state #4 (step S7).

When there is an address hit in the case where the subject entry is in the state #4, the state manager 134 causes the subject entry to transition to the state #3. Furthermore, the state manager 134 increments the confidence counter of the subject entry by 1 (step S8).

On the other hand, when there is an address miss in the case where the subject entry is in the state #4, the state manager 134 decrements the confidence counter of the subject entry by 1 while maintaining the state information of the subject entry (step S9). The state manager 134 then determines whether the value of the confidence counter is 0. When the value of the confidence counter is not 0, the state manager 134 maintains the state of the subject entry at that time. On the other hand, when the value of the confidence counter is 0, the state manager 134 causes the subject entry to transition to the state #0 to be in an invalid state (step S10).

The subject entry corresponds to an example of “a given entry”. A memory access instruction with a program counter that is registered in the subject entry after registration of the subject entry in the prefetch queue 131 until transition to the state #3 corresponds to an example of “a second memory access instruction”. A memory access instruction with a program counter registered in the subject entry after transition to the state #3 corresponds to an example of “a third memory access instruction”. In other words, the state manager 134 calculates a stride width based on a request address of the first memory instruction and respective request addresses of a plurality of second memory access instructions following the given entry and presented by the given program counter and registers the stride width in the given entry. The state manager 134 registers, in the given entry, a predicted address obtained by adding the stride width to the request address of the second memory access instruction. Furthermore, the state manager 134 sequentially updates the predicted address with a value calculated by adding the stride width to each of request addresses of a plurality of third memory access instructions following the second memory access instructions that are presented by the given program counter. The state manager 134 compares the request address of each of the third access instructions and the predicated address that is registered in the given entry and detects occurrence of a stride access.

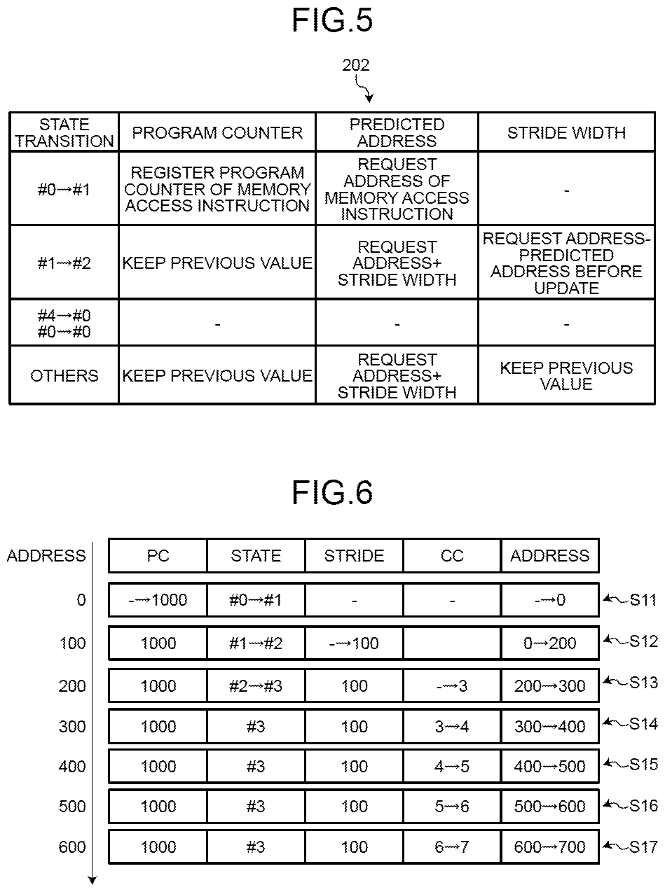

FIG. 5 is a diagram illustrating a list of information that is updated in each entry at state transition. With reference to a table 202 in FIG. 5, information excluding the confidence counter that is updated in each entry at state transition is collectively described next. In the table 202 in FIG. 5, the value of the confidence counter is omitted.

When causing the subject entry to transition from the state #0 to the state #1, the pattern monitoring unit 132 registers the program counter of the memory access instruction as the program counter of the subject entry. The pattern monitoring unit 132 registers a request address of the memory access instruction as a predicted address. In this case, the pattern monitoring unit 132 may register an appropriate value as the stride width.

When causing the subject entry to transition from the state #1 to the state #2, the state manager 134 causes the subject entry to keep the value of the program counter. The previous request address is stored as the predicted address in the address information in the case of the state #1 and thus the state manager 134 subtracts the predicted address from the request address to calculate a stride width. The state manager 134 calculates a predicted address by adding the stride width to the request address, registers the predicted address as the address information to update the address information.

When causing the subject entry to transition from the state #4 to the state #0 and when no transition is made from the state #0, the pattern monitoring unit 132 and the state manager 134 do not make any update other than an update on the confidence counter of the entry.

In cases excluding the above-described state transitions, the state manager 134 has the value of the program counter be kept. The state manager 134 maintains the stride width information. The state manager 134 calculates a predicted address by adding the stride width to the request address and registers the predicted address as the address information to update the address information.

Back to FIG. 2, the description will be continued. After the update of the state information of the subject entry, the state manager 134 determines whether a condition for issuing a prefetch request to the lower-level cache 13 with respect to the target entry is met. When the condition for issuing a prefetch request is met, the state manager 134 guesses that stride accesses according to the stride width presented by the stride width information are executed. When it is determined that the condition for issuing a prefetch request is met, the state manager 134 requests the prefetch request generator 133 to issue a prefetch request. The state manager 134 outputs the value of the program counter of the entry that meets the condition for issuing a prefetch request to the prefetch request generator 133.

The condition for issuing a prefetch request is the case where the subject entry has an address hit, the subject entry is in the state #3, and the value of the confidence counter exceeds a threshold. If the threshold of the value of the confidence counter value is large, accuracy in determining a stride access increases; however, starting of a prefetch delays. In other words, it is preferable that the threshold of the value of the confidence counter be set according to the operation in consideration of the balance between accuracy of determining a stride access and starting of prefetching. When the threshold is, for example, 6, the state manager 134 sets the confidence counter at 3 when there is an address hit in the state #1. Thereafter, when there are accesses with the same stride width sequentially for four times, the state manager 134 sets the confidence counter at 6 and determines that the condition for issuing a prefetch request is met. In other words, the state manager 134 determines that stride accesses are performed with the stride width.

The prefetch request generator 133 receives a request to issue a prefetch request together with the value of the program counter of the entry that meets the condition for issuing a prefetch request from the state manager 134. The prefetch request generator 133 then acquires stride width information from the entry having the acquired value of the program counter. The prefetch request generator 133 issues, to the lower-level cache 13, a prefetch request using an address that is calculated by adding a value obtained by multiplying the acquired stride width by a given number to the request address of the memory access instruction with respect to which a cache miss occurs. The given number is any integer value and, for example, before a memory access instruction corresponding to the address with respect to which the prefetch request is issued, a value that can be registered as data in the L1 cache is set.

FIG. 6 is a diagram illustrating an example of transition of entries in a case of uni-stride access. With reference to FIG. 6, a specific example of the transition of entries in the case of uni-stride access will be described next. Here, 100 that is a round number is used as a stride width and the cache line size is set at 50. According to FIG. 6, uni-stride access is performed and memory access instructions in which the head address is 0 and a stride width is 100 are successive. The memory access instruction has the program counter of, for example. 1000. Furthermore, the upper limit of the confidence counter to issue a prefetch is 6. The arrow in each column in FIG. 6 represents an update from the bottom of the arrow forth.

The instruction issuing unit 101 issues a request for memory access to an address having an address number of 0. When an L1 cache miss occurs, the pattern monitoring unit 132 initially registers an entry in the prefetch queue 131. The pattern monitoring unit 132 then sets the state information of the entry at the state #1, registers 1000 in the program counter, and registers 0 as the address information (step S11).

The instruction issuing unit 101 then issues a request for memory access to an address having an address number of 100. When an L1 cache miss occurs, the pattern monitoring unit 132 detects a PC hit of the entry whose program counter is at 1000. The state manager 134 subtracts 0 that is stored in the address information from 100 that is the request address to calculate that the stride width is 100. The state manager 134 then registers the calculated stride width as the stride width information and registers 200 that is a value obtained by adding 100 that is the stride width to 100 that is the request address as a predicted address in the address information. Furthermore, the state manager 134 changes the state information from the state #1 to the state #2 (step S12).

The instruction issuing unit 101 then issues a request for memory access to an address having an address number of 200. As for the memory access request, there is an address hit in which the predicted address registered in the entry whose program counter is at 1000 and the request address match and therefore the state manager 134 changes the state information from the state #2 to the state #3. Furthermore, the state manager 134 sets the confidence counter at 3. The state manager 134 registers 300 that is a value obtained by adding 100 that is the stride width to 200 that is the request address as a predicted address in the address information (step S13).

The instruction issuing unit 101 then issues a request for memory access to an address having an address number of 300. Also as for the memory access request, there is an address hit and therefore the state manager 134 increments the confidence counter. In this case, the state manager 134 causes the entry to maintain the state information and the stride width information. The state manager 134 registers 400 that is a value obtained by adding 100 that is the stride width to 300 that is the request address as a predicted address in the address information (step S14).

Also as for a request for memory access to an address number of 400 that is issued by the instruction issuing unit 101, there is an address hit and therefore the state manager 134 increments the confidence counter. In this case, the state manager 134 causes the entry to maintain the state information and the stride width information. The state manager 134 registers 500 that is a value obtained by adding 100 that is the stride width to 400 that is the request address as a predicted address in the address information (step S15).

Also as for a request for memory access to an address number of 500 that is issued from the instruction issuing unit 101, there is an address hit and therefore the state manager 134 increments the confidence counter. In this case, the state manager 134 causes the entry to maintain the state information and the stride width information. The state manager 134 registers 600 that is a value obtained by adding 100 that is the stride width to 500 that is the request address as a predicted address in the address information. Furthermore, the confidence counter is at 6 or larger and the state manager 134 determines that the condition for issuing a prefetch request is met. The state manager 134 requests the prefetch request generator 133 to issue a prefetch request. The prefetch request generator 133 executes prefetching using an address having an address number of 500+100×N that is an addition of a value obtained by multiplying 100 that is the stride width by N that is a given number to 500 (step S16).

Also as for a request for memory access to an address number of 600 that is issued from the instruction issuing unit 101, there is an address hit and therefore the state manager 134 increments the confidence counter. In this case, the state manager 134 causes the entry to maintain the state information and the stride width information. The state manager 134 registers 700 that is a value obtained by adding 100 that is the stride width to 600 that is the request address as a predicted address in the address information. Furthermore, the confidence counter is at 6 or larger and therefore the state manager 134 determines that the condition for issuing a prefetch request is met. The state manager 134 requests the prefetch request generator 133 to issue a prefetch request. The prefetch request generator 133 executes prefetching using an address having an address number of 600+100×N (step S17).

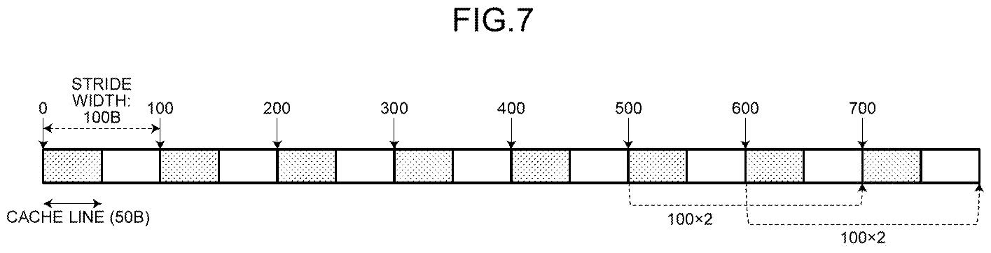

FIG. 7 is a diagram illustrating an example of accesses and prefetching in the case of uni-stride access. Here, a case where the given number N used in prefetching is 2 will be described.

As illustrated in FIG. 7, in the case of uni-stride access, an access with a stride width of 100 is repeated. Thus, the state manager 134 increases the confidence counter for every memory access instruction. Thereafter, when the confidence counter reaches an upper limit, the state manager 134 sets 100 for the stride width and causes execution of prefetching on an address having an address number obtained by adding 100×2 to the request address. In this case, prefetching succeeds because it is uni-stride access.

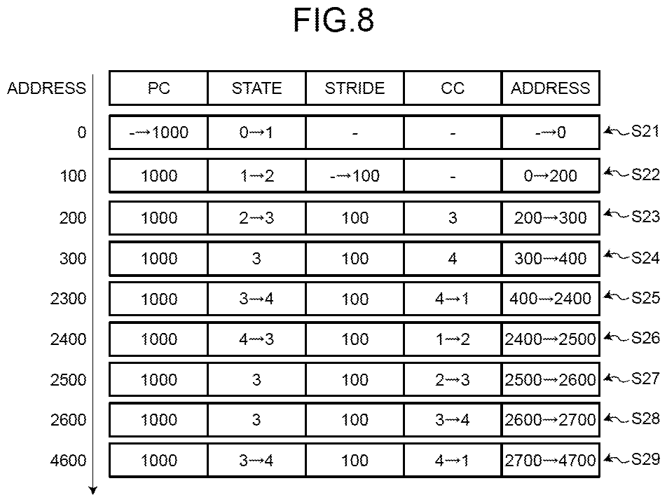

FIG. 8 is a diagram illustrating an example of transition of entries in a case of multi-stride access. With reference to FIG. 8, a specific example of transition of entries in the case of multi-stride access will be described. Here, 100 and 2000 that are round numbers are used as the stride width and the cache line size is set at 50. According to FIG. 8, multi-stride access is performed and the instruction issuing unit 101 repeats instruction issuance of issuing a memory access instruction in which a stride width is 2000 once after successively issuing a memory access instruction in which the head address is 0 and a stride width is 100 for three times. The memory access instruction has the program counter of, for example. 1000. Furthermore, the upper limit of the confidence counter to issue a prefetch is 6. The arrow in each column in FIG. 8 represents an update from the bottom of the arrow forth.

The instruction issuing unit 101 issues a request for memory access to an address having an address number of 0. When an L1 cache miss occurs, the pattern monitoring unit 132 initially registers an entry in the prefetch queue 131. The pattern monitoring unit 132 then sets the state information of the entry at the state #1, registers 1000 in the program counter, and registers 0 as the address information (step S21).

The instruction issuing unit 101 then issues a request for memory access to an address having an address number of 100. When an L1 cache miss occurs, the pattern monitoring unit 132 detects a PC hit of the entry whose program counter is at 1000. The state manager 134 subtracts 0 that is stored in the address information from 100 that is the request address to calculate that the stride width is 100. The state manager 134 then registers the calculated stride width as the stride width information and registers 200 that is a value obtained by adding 100 that is the stride width to 100 that is the request address as a predicted address in the address information. Furthermore, the state manager 134 changes the state information from the state #1 to the state #2 (step S22).

The instruction issuing unit 101 then issues a request for memory access to an address having an address number of 200. As for the memory access request, there is an address hit in which the predicted address registered in the entry whose program counter is at 1000 and the request address match and therefore the state manager 134 changes the state information from the state #2 to the state #3. Furthermore, the state manager 134 sets the confidence counter at 3. The state manager 134 registers 300 that is a value obtained by adding 100 that is the stride width to 200 that is the request address as a predicted address in the address information (step S23).

The instruction issuing unit 101 then issues a request for memory access to an address having an address number of 300. Also as for the memory access request, there is an address hit and therefore the state manager 134 increments the confidence counter. In this case, the state manager 134 causes the entry to maintain the state information and the stride width information. The state manager 134 registers 400 that is a value obtained by adding 100 that is the stride width to 300 that is the request address as a predicted address in the address information (step S24).

The instruction issuing unit 101 then issues a request for memory access to an address having an address number of 2300. As for the memory access request, there is an address miss in which the predicted address registered in the entry whose program counter is at 1000 and the request address mismatch and therefore the state manager 134 changes the state information from the state #3 to the state #4. The value of the counter is 4 and does not reach the upper limit and therefore the state manager 134 changes the confidence counter to 1. Furthermore, the state manager 134 registers 2400 that is a value obtained by adding 100 that is the stride width to 2300 that is the request address as a predicted address in the address information (step S25).

The instruction issuing unit 101 then issues a request for memory access to an address having an address number of 2400. As for the memory access request, there is an address hit in which the predicted address registered in the entry whose program counter is at 1000 and the request address match and therefore the state manager 134 changes the state information from the state #4 to the state #3. Furthermore, the state manager 134 increments the confidence counter. In this case, the state manager 134 causes the entry to maintain the state information and the stride width information. The state manager 134 registers 2500 that is a value obtained by adding 100 that is the stride width to 2400 that is the request address as a predicted address in the address information (step S26).

Also as for a request for memory access to an address number of 2500 that is issued from the instruction issuing unit 101, there is an address hit and therefore the state manager 134 increments the confidence counter. In this case, the state manager 134 causes the entry to maintain the state information and the stride width information. The state manager 134 registers 2600 that is a value obtained by adding 100 that is the stride width to 2500 that is the request address as a predicted address in the address information (step S27).

Also as for a request for memory access to an address number of 2600 that is issued from the instruction issuing unit 101, there is an address hit and therefore the state manager 134 increments the confidence counter. In this case, the state manager 134 causes the entry to maintain the state information and the stride width information. The state manager 134 registers 2700 that is a value obtained by adding 100 that is the stride width to 2600 that is the request address as a predicted address in the address information (step S28).

The instruction issuing unit 101 then issues a request for memory access to an address having an address number of 4600. As for the memory access request, there is an address miss in which the predicted address registered in the entry whose program counter is at 1000 and the request address mismatch and therefore the state manager 134 changes the state information from the state #3 to the state #4. Furthermore, because the value of the confidence counter is 4 and does not reach the upper limit, the state manager 134 changes the confidence counter to 1. Furthermore, the state manager 134 registers 4700 that is a value obtained by adding 100 that is the stride width to 4600 that is the request address as a predicted address in the address information (step S29).

As described above, the state manager 134 is able to determine that it is not uni-stride access because the confidence counter does not reach the upper limit and inhibit wrong issuance of prefetching.

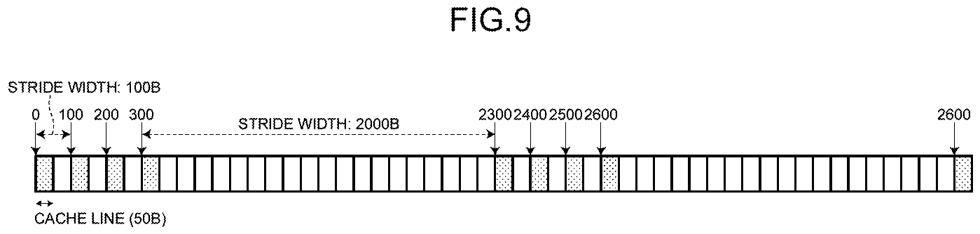

FIG. 9 is a diagram illustrating an example of accesses in the case of multi-stride access. As illustrated in FIG. 9, in the case of multi-stride access, while an access with a stride width of 100 is repeated, the state manager 134 increases the confidence counter for every memory access instruction. An access with a stride width of 2000 however occurs before the confidence counter reaches the upper limit and thus an address miss occurs and accordingly an address miss occurs and the state manager 134 reduces the value of the confidence counter. For this reason, the confidence counter does not reach the upper limit and the state manager 134 is able to avoid wrong prefetching.

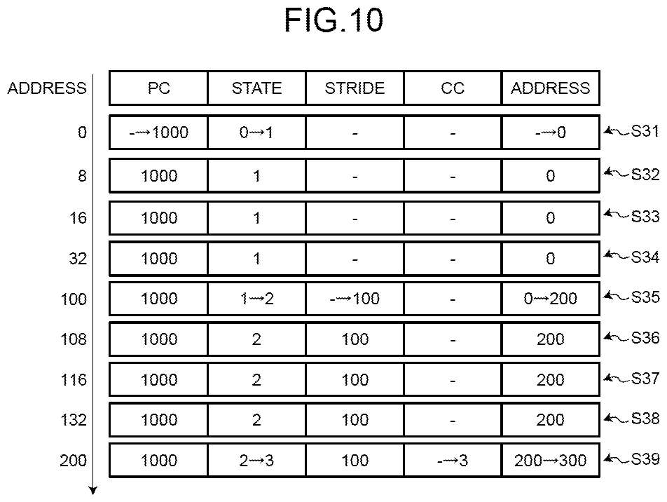

FIG. 10 is a diagram illustrating an example of transition of entries in a case of multi-stride access that is however uni-stride access when viewed on a cache line basis. Next, with reference to FIG. 10, a specific example of transition of entries in the case of multi-stride access will be described. Here, 8 and 68 are used as a stride width and the cache line size is set at 50. According to FIG. 10, multi-stride access is performed and the instruction issuing unit 101 repeats instruction issuance of issuing a memory access instruction in which a stride width is 68 once after successively issuing a memory access instruction in which the head address is 0 and a stride width is 8 for three times. In other words, in view of the unit of stride width, it can be described that the instruction issuing unit 101 repeats issuing an instruction for memory access in which the stride width is 100. The program counter is, for example, an instruction of memory access to 1000. Furthermore, the upper limit of the confidence counter to issue a prefetch is 6. The arrow in each column in FIG. 10 represents an update from the bottom of the arrow forth.

The instruction issuing unit 101 issues a request for memory access to an address having an address number of 0. When an L1 cache miss occurs, the pattern monitoring unit 132 initially registers an entry in the prefetch queue 131. The pattern monitoring unit 132 then sets the state information of the entry at the state #1, registers 1000 in the program counter, and registers 0 as the address information (step S31).

The instruction issuing unit 101 then sequentially issues requests for memory access to addresses having address numbers of 8, 16 and 32. The accesses to the addresses having the address numbers of 8, 16 and 32 are accesses to the same cache line as that of the access to the address whose address number is 0. An access of the memory access request following the previous memory access request is to the same cache line as that of the previous memory access is simply referred to as “an access to the same cache line”. The pattern monitoring unit 132 determines whether it is an access to the same cache line based on the state information, the address information, and the stride width information that are stored in the prefetch queue 131. For example, as for requests for memory access to addresses having the address numbers of 8, 16 and 32, the pattern monitoring unit 132 confirms that it is the state #1 and the stride width is not registered yet. Furthermore, the pattern monitoring unit 132 compares the address that is stored in the address information and the request address and determines that it is an access to the same cache line. When it is an access to the same cache line, the state manager 134 does not update information of the entries (steps S32 to S34).

The instruction issuing unit 101 then issues a request for memory access to an address having an address number of 100. When an L1 cache miss occurs, the pattern monitoring unit 132 detects a PC hit of the entry whose program counter is at 1000. The state manager 134 subtracts 0 that is stored in the address information from 100 that is the request address to calculate that the stride width is 100. The state manager 134 then registers the calculated stride width as the stride width information and registers 200 that is a value obtained by adding 100 that is the stride width to 100 that is the request address as a predicted address in the address information. Furthermore, the state manager 134 changes the state information from the state #1 to the state #2 (step S35).

The instruction issuing unit 101 then sequentially issues requests for memory access to addresses having address numbers of 108, 116 and 132. The accesses to the addresses having the address numbers of 108, 116 and 132 are accesses to the same cache line as that of the access to the address whose address number is 100. The pattern monitoring unit 132 determines whether it is an access to the same cache line based on the state information, the address information, and the stride width information that are stored in the prefetch queue 131. For example, as for requests for memory access to addresses having the address numbers of 108, 116 and 132, the pattern monitoring unit 132 confirms that it is the state #2 and the stride width is already registered. The pattern monitoring unit 132 compares the request address that is stored in the address information and the request address and determines that it is an access to the same cache line. When it is an access to the same cache line, the state manager 134 does not update information of the entries (steps S36 to S38).

The instruction issuing unit 101 then issues a request for memory access to an address having an address number of 200. When an L1 cache miss occurs, the pattern monitoring unit 132 detects a PC hit of the entry whose program counter is at 1000. As for the memory access request, there is an address hit in which the predicted address registered in the entry whose program counter is at 1000 and the request address match and therefore the state manager 134 changes the state information from the state #2 to the state #3. Furthermore, the state manager 134 sets the confidence counter at 3. The state manager 134 registers 300 that is a value obtained by adding 100 that is the stride width to 200 that is the request address as a predicted address in the address information (step S39).

Thereafter, the state manager 134 repeats similar operations. The operations of the state machine illustrated in FIG. 10 are the same as those of the state machine illustrated in FIG. 6 excluding accesses on which the information of the entries of the prefetch queue 131 is not updated and in which the stride width is smaller than the cache line. For this reason, the confidence counter reaches 6 as in the case illustrated in FIG. 6 and therefore the state manager 134 causes the prefetch request generator 133 to issue a prefetch request.

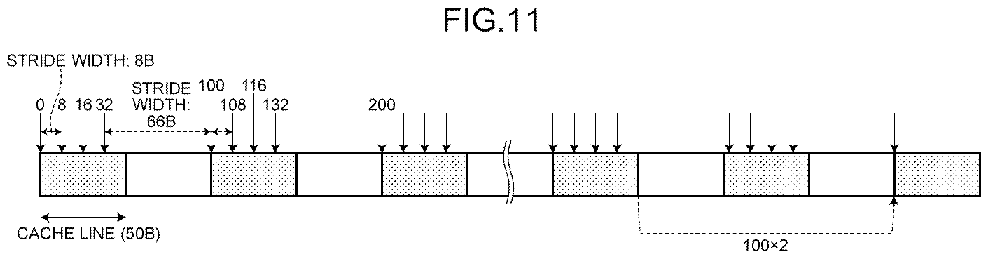

FIG. 11 is a diagram illustrating an example of accesses and prefetching in the case of multi-stride access that is however uni-stride access when viewed on a cache line basis. Here, a case where the given number N used in prefetching is 2 will be described.

As illustrated in FIG. 11, when the stride width is 8, an access to the same cache line is made. Every time the stride width changes to 68 and an access to a different cache line occurs, the state manager 134 increases the confidence counter. Thereafter, when the confidence counter reaches the upper limit, the state manager 134 sets 100 for the stride width and causes execution of prefetching on an address having an address number obtained by adding 100×2 to the request address. As described above, in the case of multi-stride access that is however uni-stride access when viewed on a cache line basis, the state manager 134 executes prefetching using the stride width that can be regarded as uni-stride access.

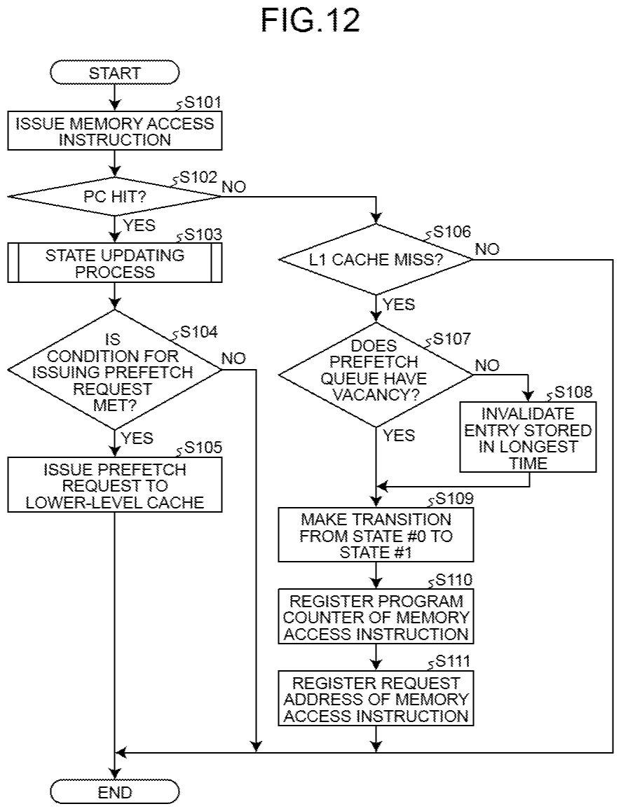

FIG. 12 is a flowchart of prefetching performed by a CPU according to the first embodiment. With reference to FIG. 12, a flow of prefetching performed by the CPU 10 according to the first embodiment will be described next.

The instruction issuing unit 101 issues a memory access instruction (step S101).

The pattern monitoring unit 132 determines whether there is an entry in which a value of a program counter of a memory access instruction is registered in the prefetch queue 131, that is, whether there is a PC hit or a PC miss (step S102).

In the case of the PC hit (YES at step S102), the pattern monitoring unit 132 notifies the state manager 134 of, together with the PC hit, information of the program counter in which the PC hit occurs. The entry in which the program in which the PC hit occurs is registered is referred to as a subject entry below. On being notified, the state manager 134 executes a state updating process on the subject entry (step S103).

Thereafter, the state manager 134 determines whether the subject entry meets the condition for issuing a prefetch request (step S104). When the subject entry does not meet the condition for issuing a prefetch request (NO at step S104), the CPU 10 ends prefetching in this time.

On the other hand, when the subject entry meets the condition for issuing a prefetch request (YES at step S104), the state manager 134 requests the prefetch request generator 133 to issue a prefetch request. On being requested, the prefetch request generator 133 generates a prefetch request and issues the generated prefetch request to the lower-level cache 13 (step S105).

On the other hand, in the case of the PC miss (NO at step S102), the pattern monitoring unit 132 notifies the L1 cache controller 102 of the PC miss. On being notified, the L1 cache controller 102 determines whether data that is specified by a request address of the memory access request is stored in the L1 cache 12, that is, whether there is an L1 cache hit or an L1 cache miss (step S106). In the case of the L1 cache hit (NO at step S106), the CPU 10 ends prefetching in this time.

On the other hand, in the case of the L1 cache miss (YES at step S106), on being notified of the L1 cache miss by the L1 cache controller 102, the pattern monitoring unit 132 determines whether the prefetch queue 131 has a vacancy in entries therein (step S107). When the prefetch queue 131 has a vacancy in the entries (YES at step S107), the pattern monitoring unit 132 goes to step S109.

When the prefetch queue 131 has no vacancy in the entries (NO at step S107), the pattern monitoring unit 132 invalidates the entry that is stored for the longest time in the prefetch queue 131 (step S108). Thereafter, the pattern monitoring unit 132 goes to step S109.

The pattern monitoring unit 132 makes a transition from the state #0 to the state #1 in the state of the subject entry (step S109).

The pattern monitoring unit 132 then registers the program counter of the memory access instruction in a new entry in the prefetch queue 131 (step S110).

Furthermore, the pattern monitoring unit 132 registers the request address of the memory access instruction as a predicted address in the address information of the entry that is registered newly (step S111).

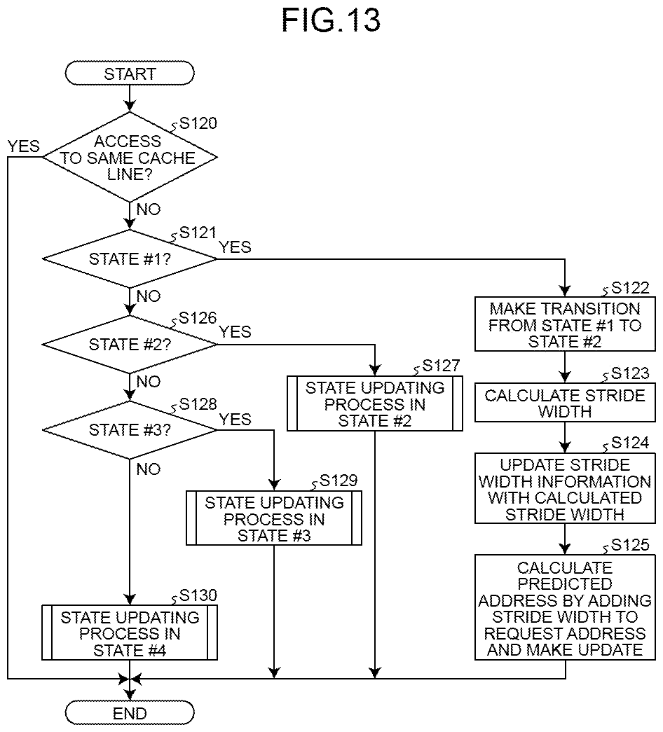

FIG. 13 is a flowchart of the state updating process performed by the state manager. The flow illustrated in FIG. 13 corresponds to an example of the process that is executed at step S103 in FIG. 12.

The pattern monitoring unit 132 determines whether the memory access request is for an access to the same cache line (step S120). When it is for the access to the same cache line (YES at step S120), the state updating process ends.

On the other hand, when it is not for the access to the same cache line (NO at step S120), the state manager 134 determines whether the subject entry is in the state #1 or not (step S121).

When the subject entry is in the state #1 (YES at step S121), the state manager 134 causes the subject entry to transition from the state #1 to the state #2 (step S122).

The state manager 134 then calculates a stride width by subtracting the predicted address that is stored in the address information of the subject entry from the request address of the memory access instruction (step S123).

The state manager 134 then registers the calculated stride width in the stride width information of the subject entry to update the stride width information (step S124).

The state manager 134 then calculates a predicted address by adding the stride width to the request address of the memory access instruction. The state manager 134 registers the calculated predicted address in the address information of the subject entry to update the address information (step S125).

On the other hand, when the subject entry is not in the state #1 (NO at step S121), the state manager 134 determines whether the subject entry is in the state #2 or not (step S126). When the subject entry is in the state #2 (YES at step S126), the state manager 134 executes the state updating process in the state #2 (step S127).

On the other hand, when the subject entry is not in the state #2 (NO at step S126), the state manager 134 determines whether the subject entry is in the state #3 or not (step S128). When the subject entry is in the state #3 (YES at step S128), the state manager 134 executes the state updating process in the state #3 (step S129).

On the other hand, when the subject entry is not in the state #3 (NO at step S128), the state manager 134 determines that the subject entry is in the state #4. The state manager 134 executes the state updating process in the state #4 (step S130).

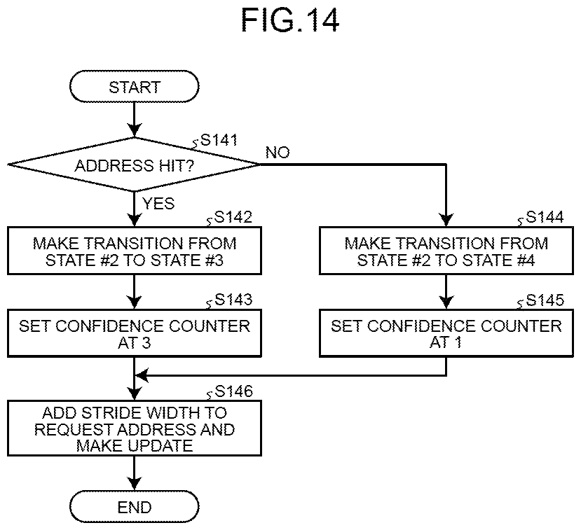

FIG. 14 is a flowchart of the state updating process in the state #2. The flow illustrated in FIG. 14 corresponds to an example of the process that is executed at step S127 in FIG. 13.

The state manager 134 determines whether there is an address hit because the request address of the memory access instruction and the predicted address that is registered in the subject entry in the prefetch queue 131 match (step S141).

When there is an address hit (YES at step S141), the state manager 134 causes the subject entry to transition from the state #2 to the state #3 (step S142).

The state manager 134 then sets the confidence counter of the subject entry at 3 (step S143). Thereafter, the state manager 134 goes to step S146.

On the other hand, when there is an address miss (NO at step S141), the state manager 134 causes the subject entry to transition from the state #2 to the state #4 (step S144).

The state manager 134 then sets the confidence counter of the subject entry at 1 (step S145). Thereafter, the state manager 134 goes to step S146.

The state manager 134 registers a value obtained by adding the stride width that is registered in the subject entry to the request address in the address information to update the address information (step S146).

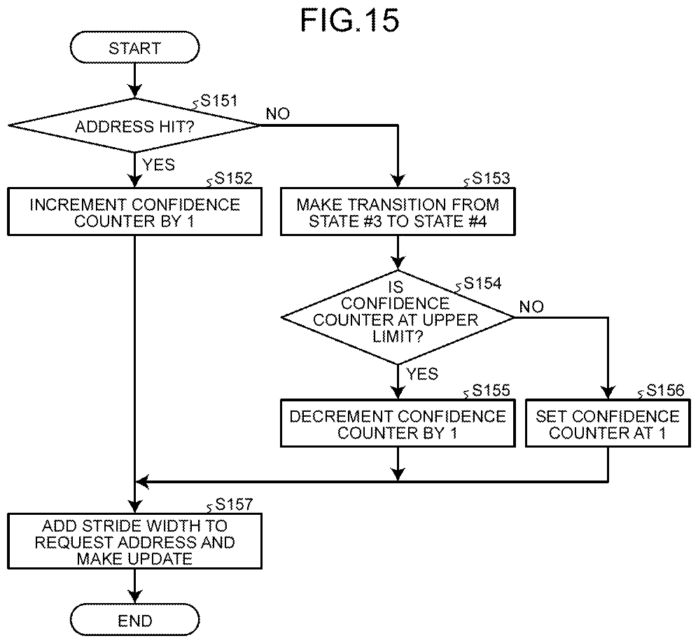

FIG. 15 is a flowchart of the state updating process in the state #3. The flow illustrated in FIG. 15 corresponds to an example of the process that is executed at step S129 in FIG. 13.

The state manager 134 determines whether there is an address hit because the request address of the memory access instruction and the predicted address that is registered in the subject entry in the prefetch queue 131 match (step S151).

When there is an address hit (YES at step S151), the state manager 134 increments the confidence counter of the subject entry by 1 (step S152). Thereafter, the state manager 134 goes to step S157.

On the other hand, when there is an address miss (NO at step S151), the state manager 134 causes the subject entry to transit from the state #3 to the state #4 (step S153).

The state manager 134 then determines whether the confidence counter reaches the upper limit (step S154).

When the confidence counter reaches the upper limit (YES at step S154), the state manager 134 decrements the confidence counter of the subject entry by 1 (step S155). Thereafter, the state manager 134 goes to step S157.

On the other hand, when the confidence counter does not reach the upper limit (NO at step S154), the state manager 134 sets the confidence counter of the subject entry at 1 (step S156). Thereafter, the state manager 134 goes to step S157.

The state manager 134 registers a value obtained by adding the stride width that is registered in the subject entry to the request address in the address information to update the address information (step S157).

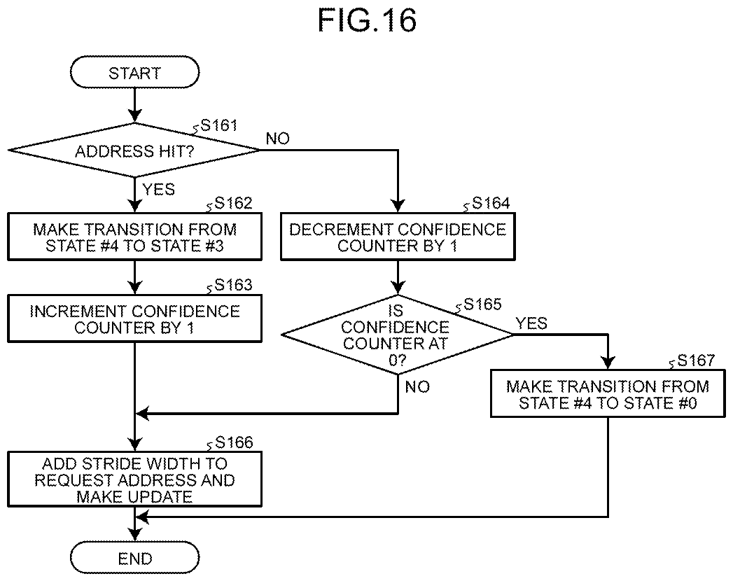

FIG. 16 is a flowchart of the state updating process in the state #4. The flow illustrated in FIG. 16 corresponds to an example of the process that is executed at step S130 in FIG. 13.

The state manager 134 determines whether there is an address hit because the request address of the memory access instruction and the predicted address that is registered in the subject entry in the prefetch queue 131 match (step S161).

When there is an address hit (YES at step S161), the state manager 134 causes the subject entry to transition from the state #4 to the state #3 (step S162).

The state manager 134 increments the confidence counter of the subject entry by 1 (step S163). Thereafter, the state manager 134 goes to step S166.

On the other hand, when there is an address miss (NO at step S161), the state manager 134 decrements the confidence counter of the subject entry by 1 (step S164).

The state manager 134 then determines whether the confidence counter is at 0 (step S165). When the confidence counter is not at 0 (NO at step S165), the state manager 134 goes to step S166.

The state manager 134 registers a value obtained by adding the stride width that is registered in the subject entry to the request address in the address information to update the address information (step S166).

On the other hand, when the confidence counter is at 0 (YES at step S165), the state manager 134 causes the subject entry to transition from the state #4 to the state #0 (step S167). Accordingly, the subject entry is invalid.

As described above, the computing device according to the first embodiment manages an entry that is stored in the prefetch queue and that is a possible entry for which prefetching would be performed, using the state machine, changes the confidence according to the stride width, and performs prefetching when the confidence reaches a certain value. Accordingly, the computing device according to the first embodiment distinguishes access patterns by uni-stride access and multi-stride access and executes stride prefetching in the case of uni-stride access. Accordingly, it is possible to inhibit prefetching using a wrong address that occurs in the case of multi-stride access and thus increases computing performance.

In the case of multi-stride access that is however uni-stride access when viewed on a cache line basis, the computing device according to the first embodiment executes prefetching using a stride width that can be regarded as uni-stride access. Accordingly, it is possible to increase frequency of performing prefetching while inhibiting prefetching using a wrong address and thus further increase the computing performance.

### (b) Second Embodiment

A second embodiment will be described next. The CPU 10 according to the second embodiment is also presented using the block diagram in FIG. 2. The CPU 10 according to the second embodiment is different from that of the first embodiment in performing replacement of an entry in the prefetch queue 131 using a state machine for controlling replacement control. Replacement of an entry performed by the CPU 10 according to the second embodiment will be described in detail below. In the following description, description of the same operations of each unit to those of the first embodiment will be omitted.

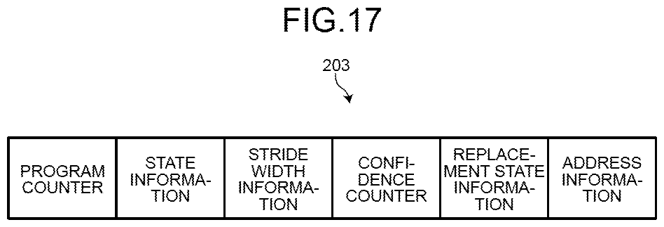

FIG. 17 is a diagram illustrating an example of a format of entries that are stored in a pre-fetch queue according to the second embodiment. As illustrated in a format 203 in FIG. 17, a program counter, state information, a confidence counter, replacement state information, and address information are registered in each entry of the prefetch queue 131.

The replacement state information is information presenting a state of an entry that is used in control for replacement of the entry, that is, deleting and invalidating the entry. There are states #R0 to #R3 as the replacement state. The replacement state #R0 represents a state in which the entry is invalid. In other words, when a specific entry transitions to the replacement state #R0, the specific entry is invalidated.

When there is no PC hit and an L1 cache miss occurs, the pattern monitoring unit 132 determines whether the prefetch queue 131 has a vacancy in entries therein. When there is a vacancy in the entries, the pattern monitoring unit 132 sets, at the state #1, the state information of an entry to be registered newly with respect to the memory access instruction on which the L1 cache miss occurs. The pattern monitoring unit 132 sets, at a replacement state #R2, the replacement state information of the entry that is newly registered. The pattern monitoring unit 132 sets, at a program counter of the memory access instruction, the program counter of that entry that is registered newly. The pattern monitoring unit 132 registers a request address of the memory access instruction as a predicted address in the address information of the entry that is newly registered. Here, because the stride width information is invalid in the state #1, the pattern monitoring unit 132 registers a freely selected value, such as an initial value that is determined previously, as stride width information. The pattern monitoring unit 132 registers the new entry with the above-described content in the prefetch queue 131.

On the other hand, when the prefetch queue 131 has no vacancy in the entries, the pattern monitoring unit 132 selects an entry that meets any one of the following two conditions as an entry to be replaced. The first condition is a condition that an entry that is in the state #4 and whose confidence counter is at or under a confidence threshold is selected. The pattern monitoring unit 132 is able to set the confidence threshold at 2. The first condition is a condition on the ground that access with regular occurrence of an address miss is not used for stride prefetching and therefore is wanted to be excluded from the entries. As for the access with regular occurrence of an address miss, because the confidence counter is at or under the confidence threshold regularly, the pattern monitoring unit 132 is able to select the entry corresponding to the access as an entry to be replaced.

The second condition is a condition that an entry that is set in the replacement state #R0 in the state machine for replacement control is invalidated. In other words, when there is no entry meeting the first condition without vacancy in the entries, the pattern monitoring unit 132 generates a decrement event in the state machine for replacement control. The decrement event is an event in which each of all the entries is caused to transition to a replacement state of a previous number. When a decrement event is repeated for few times, because an entry in the replacement state #R0 occurs in the entries, the pattern monitoring unit 132 is able to invalidate the entry according to the second condition. When the replacement state information of an entry is the replacement state #R0, the pattern monitoring unit 132 also updates the state information of the entry to the state #0.

When there is a PC hit, because an entry in the replacement state #R0 does not occur, the pattern monitoring unit 132 selects an entry to be replaced using the first condition. When there is a PC miss, the confidence counter is not updated and therefore there is a possibility that there is no entry meeting the first condition; however, PC hits stop and accordingly any one entry enters the replacement state #R0 and the second condition is met.

When a PC hit occurs, the pattern monitoring unit 132 updates the replacement state information of the subject entry to the replacement state #R3. Furthermore, when state information of an entry is the state #0, the pattern monitoring unit 132 also updates the replacement state information of the entry to the replacement state #R0.

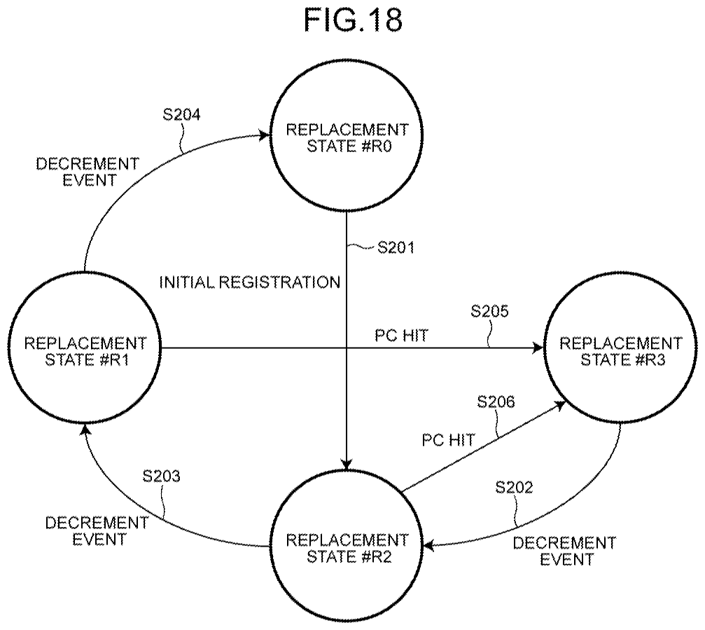

FIG. 18 is a diagram illustrating an example of the state machine for replacement control. With reference to FIG. 18, transition of the replacement state will be described collectively.

When a PC miss occurs with respect to a received memory access instruction and an L1 cache miss occurs, the pattern monitoring unit 132 newly registers an entry having a program counter of the memory access instruction. The pattern monitoring unit 132 perform initial registration of setting the state information of the newly-registered entry at the state #1 and setting the replacement state information at the replacement state #R2 (step S201).

When a PC miss occurs with respect to a received memory access instruction and an L1 cache miss occurs and an entry is newly registered, the pattern monitoring unit 132 executes the following process. In other words, when the prefetch queue 131 has no vacancy in the entries and there is no entry meeting the first condition, the pattern monitoring unit 132 generates a decrement event (steps S202, S203 and S204). This leads to a possibility that the entry can be invalidated and, when the entry is invalidated, the pattern monitoring unit 132 is able to newly register an entry with respect to the memory access instruction.

In the case where a PC hit occurs, even when the subject entry is in any one of the replacement states #R1 and #R2, the pattern monitoring unit 132 causes the entry to transition to the replacement state #R3 (steps S205 and S206).

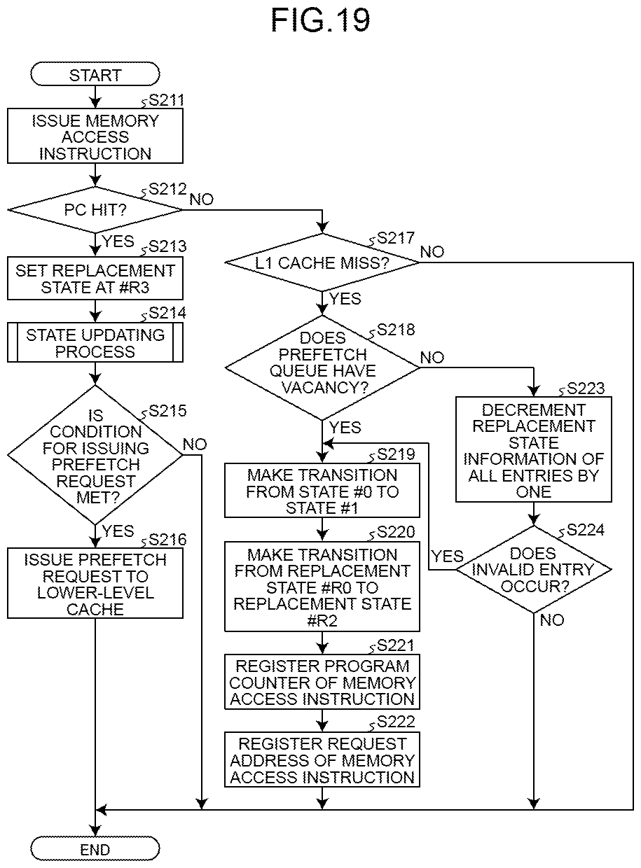

FIG. 19 is a flowchart of pre-fetching performed by THE CPU according to the second embodiment. With reference to FIG. 19, a flow of prefetching performed by the CPU 10 according to the second embodiment will be described next.

The instruction issuing unit 101 issues a memory access instruction (step S211).

The pattern monitoring unit 132 determines whether there is an entry in which a value of a program counter of a memory access instruction is registered in the prefetch queue 131, that is, whether there is a PC hit or a PC miss (step S212).

In the case of the PC hit (YES at step S212), the pattern monitoring unit 132 updates the subject entry in which the PC hit occurs to the replacement state #R3 (step S213).

The pattern monitoring unit 132 notifies the state manager 134 of, together with the PC hit, information of the program counter in which the PC hit occurs. The entry in which the program in which the PC hit occurs is registered is referred to as a subject entry below. On being notified, the state manager 134 executes the state updating process on the subject entry (step S214).

Thereafter, the state manager 134 determines whether the subject entry meets the condition for issuing a prefetch request (step S215). When the subject entry does not meet the condition for issuing a prefetch request (NO at step S215), the CPU 10 ends prefetching in this time.

On the other hand, when the subject entry meets the condition for issuing a prefetch request (YES at step S215), the state manager 134 requests the prefetch request generator 133 to issue a prefetch request. On being requested, the prefetch request generator 133 generates a prefetch request and issues the generated prefetch request to the lower-level cache 13 (step S216).

On the other hand, in the case of the PC miss (NO at step S212), the pattern monitoring unit 132 notifies the L1 cache controller 102 of the PC miss. On being notified, the L1 cache controller 102 determines whether data that is specified by a request address of the memory access request is stored in the L1 cache 12, that is, whether there is an L1 cache hit or an L1 cache miss (step S217). In the case of the L1 cache hit (NO at step S217), the CPU 10 ends prefetching in this time.

On the other hand, in the case of the L1 cache miss (YES at step S217), on being notified of the L1 cache miss by the L1 cache controller 102, the pattern monitoring unit 132 determines whether the prefetch queue 131 has a vacancy in entries therein (step S218).

When the prefetch queue 131 has a vacancy in the entries (YES at step S218), the pattern monitoring unit 132 registers a new entry in the prefetch queue 131 and causes the entry to transition from the state #0 to the state #1 (step S219).

The pattern monitoring unit 132 makes a transition in the replacement state information of the newly registered entry from the replacement state #R0 to the replacement state #R2 (step S220).

The pattern monitoring unit 132 then registers the program counter of the memory access instruction in the newly recorded entry (step S221).

Furthermore, the pattern monitoring unit 132 registers the request address of the memory access instruction as a predicted address in the address information of the entry that is registered newly (step S222).

On the other hand, when the prefetch queue 131 has no vacancy in the entries (NO at step S218), the pattern monitoring unit 132 executes a decrement event in which the replacement state information of all the entries is decremented by 1 (step S223).

Thereafter, the pattern monitoring unit 132 determines whether an entry whose replacement state enters #R0 because of the decrement event and that is invalidated occurs (step S224).

When an invalid entry occurs (YES at step S224), the pattern monitoring unit 132 returns to step S219. On the other hand, when an invalid entry does not occur (NO at step S224), the pattern monitoring unit 132 ends the prefetching in this time.

As described above, the computing device according to the second embodiment selects, from the prefetch queue, the entry to be replaced using the first condition that is used for prefetching control and that is based on the state and the confidence counter and the second condition that is used for replacement control and that is based on the state. The computing device is able to invalidate the entry in which an address miss occurs regularly and that is not used for stride prefetching according to the first condition. When the first condition is not met, the computing device is able to invalidate the entry in which the period without occurrence of a PC hit is long and that has a low probability of being used for stride prefetching according to the second condition.

Accordingly, the computing device according to the second embodiment enables invalidation from the entry that has a low possibility of being used for stride prefetching and enables an increase in probability of execution of stride prefetching. This enables an increase in computing performance of the computing device.

The computing device including the prefetch system described above is usable in general computer and, for example, is installable in a computer that is used for a server or high performance computing (HPC). Particularly, prefetching by the computing device is effective in processing with a lot of stride accesses in a computer for a data center, in processing repeated using functions, loop processing including arrays, etc.

According to one aspect, the disclosure makes it possible to increase computing performance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computing device comprising:
a memory; and
a processor coupled to the memory and configured to:
calculate a stride width based on request addresses of respective two memory access instructions that are presented by a given program counter and detect occurrence of a stride access based on request addresses of a plurality of memory access instructions that are presented by the given program counter and the calculated stride width; and
issue a prefetch request based on the stride width when the stride access is detected.

2. The computing device according to claim 1, further including: a prefetch queue;
wherein the processor is further configured to,
register the given entry containing the information of the given program counter in the prefetch queue, when a cache miss occurs with respect to a first memory access instruction that is presented by the given program counter and a given entry containing information of the given program counter is not in the prefetch queue, and
calculate the stride width based on a request address of the first memory access instruction and respective request addresses of a plurality of second memory access instructions following the given entry and presented by the given program counter and register the stride width in the given entry, register a predicted address that is calculated by adding the stride width to the request address of the second memory access instruction in the given entry, sequentially update the predicted address with a value calculated by adding the stride width to each of request addresses of a plurality of third memory access instructions following the second memory access instructions and presented by the given program counter, compare each of the request addresses of the third memory access instructions with the predicted address that is registered in the given entry, and detect occurrence of stride access.

3. The computing device according to claim 2, wherein the processor is further configured to, increase a confidence counter when the request address of the third memory access instruction and the predicted address that is registered in the given entry match, reduce the confidence counter when the request address of the third memory access instruction and the predicted address that is registered in the given entry do not match, and detect the stride access using the stride width that is registered in the given entry when the confidence counter exceeds an upper limit.

4. The computing device according to claim 1, wherein the processor is further configured to issue, when the manager detects the occurrence of the stride access, a prefetch request using an address obtained by adding a value obtained by multiplying the stride width by a certain number to the request address of the memory access instruction that is presented by the given program counter.

5. The computing device according to claim 2, wherein the processor is further configured to select, when the prefetch queue has no vacancy to register the given entry, one of a plurality of entries that are stored in the prefetch queue, invalidate the selected entry, and register the given entry.

6. The computing device according to claim 5, wherein the processor is further configured to select an entry to be invalidated based on frequency of issuance of a memory access instruction that is presented by a program counter that is contained in each of the entries stored in the prefetch queue.

7. A computer implemented computing method comprising:
calculating a stride width based on request addresses of respective two memory access instructions that are presented by a given program counter;
detecting occurrence of a stride access based on request addresses of a plurality of memory access instructions that are presented by the given program counter and the calculated stride width; and
issuing a prefetch request based on the stride width when the stride access is detected, by a processor.
